(19) United States
(12) Patent Application Publication
(10) Pub. No.: US 2007/0013529 A1
(43) Pub. Date: Jan. 18, 2007

(54) Associated patient care items

(76) Inventors: Allen B. Kantrowitz, Williamstown, MA (US); In K. Mun, Nanuet, NY (US)

Correspondence Address: GIFFORD, KRASS, GROH, SPRINKLE & CITKOWSKI, P.C, PO BOX 7021, TROY, MI, 48007-7021, US

(21) Appl. No.: 11/488,321

(22) Filed: Jul. 18, 2006

Related U.S. Application Data
(60) Provisional application No. 60/700,063, filed on Jul. 18, 2005.

(51) Int. Cl. G08B 23/00

(52) U.S. Cl. 340/573.4; 340/572.1; 235/380; 340/10.1

(57) ABSTRACT

Systems and methods for decreasing errors in patient care by ensuring correct correlation between a patient and items intended for use in care of the patient are provided. In particular, an inventive set of associated items is provided in which each of the items is labeled with related identification information contained in machine readable wireless tags attached to the items. In one configuration, an identification badge to be worn by a patient and a specimen container for holding a specimen obtained from the patient are provided, each labeled with a machine readable wireless tag. Also, a kit for use in patient care is provided which includes an associated set of items and may further include a syringe, a needle, gauze, a cleansing wipe, a bandage, a tourniquet, or a glove.

### RELATED APPLICATION

This application claims priority of U.S. Provisional Patent Application Ser. No. 60/700,063 filed Jul. 18, 2005, which is incorporated herein by reference.

### FIELD OF THE INVENTION

The invention relates to management of patient care and items designed for use in minimizing patient care errors. In particular, the invention relates to items for use in patient care labeled with machine readable wireless identification tags so as to indicate a relationship between the items.

### BACKGROUND OF THE INVENTION

Patient care becomes more complex as hospitals increase capacity to treat individuals in both outpatient and inpatient settings. A consequence of the greater number of patients seen each day is an increase in the probability of error associated with ordering, obtaining, handling and processing of the specimens required for treatment and diagnosis of many patients. Further, emergency medical settings are particularly vulnerable to circumstances which lend themselves to error in patient sample handling. Previous methods of keeping track of a patient specimen container include manual completion of paperwork, always subject to difficulties such as illegibility, destruction, loss and association of such paperwork with the incorrect specimen, potentially resulting in delay of correct results, or worse, incorrect diagnosis or treatment of the patient.

Thus, improved systems and methods for ensuring correct correlation between a patient and items intended for use in care of the patient, such as a patient sample container, are needed.

### SUMMARY OF THE INVENTION

An associated set of items for use in patient care is provided which includes a first item and a second item, each item housing a machine readable wireless tag containing identification information. Preferably, the identification information contained in the first and second tags is indicative of a relationship between the first and second items. The identification information is optionally further associated with patient data, such as a patient name, diagnosis or hospital ID number.

In a preferred embodiment, one of the items is an identification badge to be worn by a patient. Also preferred is an embodiment in which an associated set of items includes an identification badge to be worn by a patient and a specimen container for holding a specimen obtained from the patient. Other items included in an associated set include a second identification badge, a specimen preparation substrate and an attachable label. Optionally, items may further include a substrate for a written indication of patient information.

An identification badge, which is one of an associated set of items, is optionally provided in the form of a wristband. In a further option, an identification badge is configured to be attached to an article of patient clothing, such as a hospital gown.

Machine readable wireless tags attached to items included in an associated set of items are any of various types including passive, active, read-only or read/write radio frequency tags.

Further provided is a kit for use in patient care which includes an associated set of items packaged together. An inventive kit optionally further includes an item for use in collection of a patient sample such as a syringe, a needle, gauze, a cleansing wipe, a bandage, a tourniquet, or a glove.

Also provided is a system for use in patient care which includes an associated set of items and a machine readable wireless tag reader. Optionally included in an inventive system is a machine tag reader operative to write information to a machine readable wireless tag. A computer connected to the reader by wireless or wired data communication may also be provided in an inventive system.

### BRIEF DESCRIPTION OF THE DRAWINGS

FIG. 1 is a drawing illustrating an embodiment of an inventive system.

FIG. 2 is a drawing illustrating an embodiment of an inventive system.

### DETAILED DESCRIPTION OF THE INVENTION

Systems and methods for decreasing errors in patient care by ensuring correct correlation between a patient and items intended for use in care of the patient are provided. In particular, an inventive set of associated items is provided in which each of the items is labeled with related identification information contained in radio frequency identification tags attached to the items. The items are linked with the patient by 1) attachment of one of the items to the patient and/or 2) input of identification information and patient data identifying the patient into a database indicating a relationship between the identification information and patient data.

In a preferred embodiment, the items are “pre-associated” with each other. The term “pre-associated” as used herein is intended to indicate that items are labeled with identifying formation that is indicative of a relationship between the items. For example, at least a portion of the identification information contained in machine readable wireless tags attached to an associated set of items may be identical, such that each item having an attached tag with a particular identification number or code is defined as associated with any other item in the system having that identification number or code. In a preferred option, tags further contain information relating to the type of item to which the label is attached. Thus, a tag may include information signifying attachment to an identification badge or a blood specimen container for example.

As used herein a machine readable wireless identification tag is defined to include a radio frequency identification (RFID) tag, one-dimensional or two-dimensional barcode.

An associated set of items for use in patient care includes at least two items, each of which houses a machine readable wireless tag containing identification information. In a preferred embodiment, a set of associated items includes an identification badge to be worn by a patient along with at least one other item for use in patient care. Other items which may be included in an inventive set of associated items include a second identification badge, a specimen container, and a specimen preparation substrate such as a slide for preparation of patient cells or other material obtained from the patient for analysis. Further items suitable for use in an inventive set of associated items include an attachable label with a radio frequency tag for labeling of patient clothing or other personal effects upon admission to a hospital or treatment facility or in an ambulance or emergency care bay.

In a preferred embodiment, systems and methods for ensuring correct correlation between a patient and a patient sample container are provided by the present invention. Thus, in this embodiment, a pre-associated set of items for use in patient care provided by the present invention includes an identification badge and a specimen container, each of which has an attached machine readable wireless tag storing associated identification information.

An identification badge included in an inventive set of associated items is configured to be worn by a patient or attached to clothing worn by the patient. In a preferred embodiment the identification badge is configured as a wristband. A wristband badge is typically configured as an elongated flexible strip having at least an external surface of biocompatible material. A wristband is provided with an attachment element in order to secure the wristband about the wrist of a patient. For example, an attachment element may be an adhesive coating on a portion of the wristband such that contact of the adhesive coating on the portion of the wristband with a second portion of the wristband secures the wristband to the patient's wrist. Other attachment elements for wristbands are known and may be used in securing a wristband included in an inventive set of associated items. For example, each end of the wristband may by configured so as to form an interlocking fastener, such as a buckle. It is understood that a badge configured as described for use as a wristband may also be produced in appropriate sizes in order to be secured to other body parts of the patient such as a finger, neck, leg, waist, ankle, or toe. In other embodiments the identification badge wearable by a patient is configured to be affixed to an item of patient clothing. In an illustrative example, an identification badge may be affixed to an item of patient clothing by an adhesive or by a mechanical fastener.

A radio frequency tag is attached to the wristband badge. For example, radio frequency tag circuitry may be layered between sheets of a sheet material such as paper or plastic. Further, tag circuitry may be printed or deposited on a portion of material incorporated in the wristband.

In one embodiment, more than one identification badge is included in a set of items according to the invention. Multiple badges are used in a situation such as an emergency childbirth in which it is desirable to ensure that correct identification of mother and child is maintained. For example, following an emergency birth, the mother and child may be separated to undergo medical treatment. Use of an inventive associated set of items including multiple badges prevents Disassociation of mother and child.

Various types of tag and reader combinations may be used in an inventive system and method. In one embodiment, the tags are passive RFID tags or barcodes, those that transmit information only in response to interrogation by a reader. In general, a passive tag is energized to transmit identification information by the reader. Passive tags may include an energy source, such as a battery, for example to increase read range. Such tags are often termed semi-passive or battery-assisted passive. In another embodiment, the tags are active and may initiate information transmission. Active tags are powered by an energy source, such as a battery, and may transmit continuously or intermittently. Numerous radio frequency identification readers and tags have been developed illustratively including those described in U.S. Pat. Nos. 4,442,507; 4,796,074; 5,095,362; 5,296,722; 5,347,263; 5,347,280; 5,378,880; 5,407,851; 5,430,441; 5,528,222; 5,550,547; 5,521,601; 5,541,604; 5,565,846; 5,682,143; and 5,625,341.

In one embodiment, the radio frequency tags are read-only. Such tags are known in the art and are exemplified by the “ES600-Series Read Only Tags” commercially available from Escort Memory Systems (EMS), Scotts Valley, Calif. Alternatively, tags are configured to allow information to be written to the tag. For instance, the patient's name, address, hospital ID and/or medical information may be written to the RFID tags. Identification information transmitted by the tags is received by the reader. Association between the identification information transmitted by the badge tag and by the container tag assures correct correlation between the patient and the patient sample container. Read-write tags are known in the art and include IntelliTag Series from Intermec Technologies Corporation and the HMS-100 Series passive read-write tags available from EMS.

A system for use in patient care is used with a machine readable wireless reader which is optionally provided along with an inventive set of associated items.

Appropriate readers include a stand-alone reader with circuitry operative to store and retrieve identity information and associated patient data. Such devices illustratively include an RFID reader with database and processor components, a personal digital assistant having an RFID reader capability or personal computer having RFID reader capability and a one-dimensional or two-dimensional barcode reader.

Also appropriate for use in conjunction with an inventive set of items is a reader connected or connectable to a database and processor by wireless network or a wired connection.

In such a system, identification information and patient data may be input from a reader device over a wired or wireless connection to a server or other computer system. The server may be any type of computer system such as a personal digital assistant, personal computer, workstation or mainframe computer.

In use, an identification badge having a machine readable wireless tag with associated identification information is affixed to the patient's body, as is generally the case with a badge in the form of a wristband, or to the patient's clothing. A patient specimen such as a blood sample is acquired and placed in a container having a machine readable wireless tag with associated identification information. A reader is activated to transmit an interrogation signal to a tag. The identification information received by the reader from the tag in response to the interrogation signal may be input to a database for later retrieval. Advantages of an inventive set of associated items are readily seen, particularly in an emergency care situation or crowded care facility. Association of the items allows a practitioner to save time and prevent confusion by use of the items. Further, input of identification information to record the use of the items is nearly instantaneous and since no written transposition of identification information is necessary, mistakes are avoided.

In one embodiment identification information contained in a machine readable wireless tag attached to an item for use in patient care is further associated with patient data. For example, a reader interrogates a tag attached to an identification badge and receives identification information from the tag. The identification information received by the reader is input into a database either in the reader or in a connected device. Patient data, such as name, address, diagnosis, condition, date and time of admission or the like, are also input to a database and correlated with the identification information. Further, data relating to associated items and their use may be input to a database. For example, identification information may be read from a sample container by medical personnel at or about the time the sample is taken and information input to a database to indicate that the container has been used, the type of sample taken, the destination of the sample, the test to be performed, time and date the sample was obtained and the like.

Optionally, a written indicator of identification, such as an ID number or name, is affixed to the badge and/or the specimen container along with the tag. In such an embodiment a substrate for inclusion of the written indicator is optionally provided attached or attachable to the item.

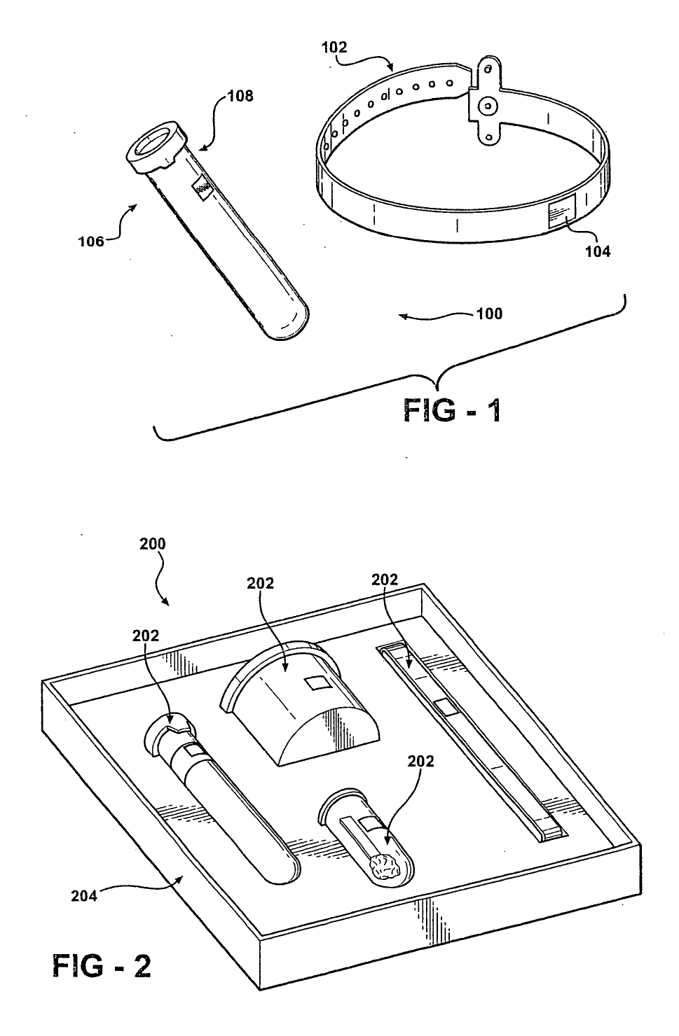

Referring to FIG. 1, an associated set of items for use in patient care is shown at 100 including an identification badge 102 having an attached radio frequency tag 104, the badge 102 in the form of a wristband. Also shown is a specimen container 106 which has an attached radio frequency tag 108 having associated identification information.

A kit for use in patient care is provided which includes an associated set of items as described herein packaged together. Optionally, instructions for use of the items are included. Optionally an inventive kit includes an item for use in collection of a patient sample such as a syringe, a needle, gauze, a cleansing wipe, a bandage, a tourniquet, or a glove.

FIG. 2 illustrates an inventive kit 200 in which an associated set of items 202 is included in a package 204.

While this application describes embodiments of the invention as including a radio frequency transponder or tag, it is appreciated that devices using other signal types are operative in embodiments of the present invention. For example, infrared reader/tag combinations or barcodes may be used.

Any patents or publications mentioned in this specification are herein incorporated by reference to the same extent as if each individual publication was specifically and individually indicated to be incorporated by reference.

One skilled in the art will readily appreciate that the present invention is well adapted to carry out the objects and obtain the ends and advantages mentioned, as well as those inherent therein. The apparatus and methods described herein are presently representative of preferred embodiments, exemplary, and not intended as limitations on the scope of the invention. Changes therein and other uses will occur to those skilled in the art. Such changes and other uses can be made without departing from the scope of the invention as set forth in the claims.

1. An associated set of items for use in patient care, comprising:
a first item for use in patient care, the first item housing a first machine readable wireless tag containing identification information; and
a second item for use in patient care, the second item housing a second machine readable wireless tag containing identification information.

2. The associated set of items of claim 1 wherein the first item is an identification badge to be worn by a patient.

3. The associated set of items of claim 2 wherein the second item is a specimen container for holding a specimen obtained from the patient.

4. The associated set of items of claim 1 wherein the second item is selected from the group consisting of: a second identification badge, a specimen preparation substrate and an attachable label.

5. The associated set of items of claim 2 wherein the identification badge is a wristband.

6. The associated set of items of claim 1 wherein the first and second tags are passive radio frequency tags.

7. The associated set of items of claim 1 wherein the first and second tags are active radio frequency tags.

8. The associated set of items of claim 2 wherein the identification badge to be worn by a patient is affixed to an item of patient clothing.

9. The associated set of items of claim 1 wherein the first and second tags are barcode tags.

10. The associated set of items of claim 1 wherein the first and second radio frequency tags are read/write radio frequency tags.

11. The associated set of items of claim 1 wherein the identification information contained in the first and second tags is indicative of a relationship between the first and second items.

12. The associated set of items of claim 1 wherein the first item and/or second item further comprises a substrate for a written indicator of identity.

13. A kit for use in patient care, comprising:
an associated set of items according to claim 1 included together in a package.

14. The kit for use in patient care of claim 13 further comprising:
an item for use in collection of a patient sample selected from the group consisting of: a syringe, a needle, gauze, a cleansing wipe, a bandage, a tourniquet, and a glove.

15. A system for use in patient care, comprising:
an associated set of items according to claim 1; and
a machine readable wireless reader.

16. The system of claim 15 wherein the tag reader is operative to write information to a radio frequency tag.

17. The system of claim 16 further comprising a computer in connection with the reader.
